(19) United States
(12) Patent Application Publication
(10) Pub. No.: US 2017/0065119 A1
(43) Pub. Date: Mar. 9, 2017

(54) Vessel for the Preparation of Infusion Beverages

(71) Applicant: EM-2 GMBH, Wutha-Farnroda (DE)

(72) Inventors: Rene HORNUNG, Eisenach (DE); Jens WOLF, Tonna (DE)

(21) Appl. No.: 15/122,563

(22) PCT Filed: Mar. 4, 2015
(86) PCT No.: PCT/EP2015/054477

§ 371 Date: Aug. 30, 2016

(30) Foreign Application Priority Data
Mar. 7, 2014 (DE) 20 2014 002 154.6

(51) Int. Cl. A47J 31/18

(52) U.S. Cl. CPC A47J 31/18

(57) ABSTRACT

The invention relates to a vessel for the preparation of infusion beverages with a retaining volume for insoluble infusion constituents, consisting of a vessel body with a bottom which is formed as an inclined plane and converges at the base point into the retaining volume. In accordance with the invention, the retaining volume is formed as a reservoir space which comprises a flat bottom section extending beneath the inclined plane, a connecting section directed towards the inclined plane, and, opposite the connecting section, a bulbous retaining section which is effective during the pouring-out or drinking process in such a way that the infusion liquid level is prevented from dropping below the level of the insoluble infusion constituents.

The invention relates to a vessel for the preparation of infusion beverages with a retaining volume for insoluble infusion constituents, consisting of a vessel body with a bottom which is formed as an inclined plane and converges at the base point into the retaining volume, according to the preamble of claim 1.

A vessel in form of a coffee cup in which coffee or tea can be brewed without a filter is known from the German utility model DE 1 637 164 U1. This vessel consists in the bottom part of a cavity in which coffee grounds or tea leaves can settle. As far as is shown in the drawings, the bottom of the aforementioned vessel comprises a bulbous portion which is directed towards the interior volume of the vessel for retaining insoluble infusion constituents.

In a practical application of the aforementioned vessel, it is likely during the drinking process that insoluble constituents are entrained despite the cavity, leading to the consequence of impaired drinking pleasure.

On the basis of the aforementioned statement, it is therefore the object of the invention to provide a further developed vessel for the preparation of infusion beverages whose retaining volume for insoluble infusion constituents is further developed in such a way that under all imaginable circumstances of use the insoluble constituents such as tea leaves or coffee grounds are retained securely. Furthermore, the vessel shall be similar in respect of its outer appearance to known pots or drinking vessels and hide its special functional properties by way of design. Finally, the flow conditions during discharge of the vessel shall be realised in such a way that mixing of the insoluble constituents with the infusion or drinking liquid is prevented, but at least minimised.

This object of the invention is achieved by the feature combination according to claim 1, wherein the dependent claims represent at least appropriate embodiments and further developments.

A vessel for the preparation of infusion beverages is therefore provided which contains a retaining volume for insoluble infusion constituents. Said retaining volume is an integral component of the vessel. The vessel per se consists of a vessel body, e.g. from a fired ceramic material, wherein the vessel body comprises a bottom formed as an inclined plane, which at the base point converges into the retaining volume. Said bottom of the vessel body is represented as an inner bottom which can be surrounded by an outer bottom, which represents a desirable flat support surface. Support elements can be provided alternatively on the basis of the bottom formed as an inclined plane in order to securely place the vessel. It is relevant that in the state of brewing the inclined plane fulfils its effect concerning the gravity-induced movement of insoluble infusion constituents.

In accordance with the invention, the retaining volume is formed as a special reservoir space.

Said reservoir space comprises a flat bottom section which extends beneath the inclined plane. Furthermore, there is a connecting section facing the inclined plane and a bulbous retaining section which is opposite the connecting section and is effective during the pouring-out or drinking process.

The retaining section in particular is formed in such a way that the infusion liquid level is prevented from sinking below the level of the insoluble infusion constituents. It is thus prevented that insoluble infusion constituents are entrained.

In a preferred embodiment of the invention, the vessel comprises a spout-shaped outlet which is formed above the reservoir space at the upper edge of the vessel body.

A recess is disposed in accordance with the invention between the retaining section and the spout which converges into a funnel segment in order to suppress a flow-induced swirling of infusion components situated in the reservoir space during the pouring-out or drinking process.

Cascade-shaped projections and recesses are provided on the vessel body above the reservoir space in a further embodiment of the invention. Said cascade-shaped projections and recesses produce an additional retaining of insoluble infusion constituents during the drinking or pouring-out process.

The projections and recesses can form the entire wall structure of the vessel body, but can also only be provided alternatively only on the inside of the vessel body.

In the case of a formation of said projections and recesses over the vessel body structure, this quasi-undulating form can also be used for securely holding the drinking vessel and can thus be formed circumferentially around the vessel.

The vessel body has a cylindrical, partly cylindrical or oval shape in a preferred but not exclusive embodiment of the vessel.

In a further preferred manner, the inclined plane is realised not only over a portion of the vessel bottom, but by filling the entire vessel bottom with the exception of the retaining volume. In this case, the inclined plane can be used as a brewing surface during the process of infusion.

The vessel in accordance with the invention can both be formed as a simple drinking vessel, a cup with or without handle, or as a classic pot in which the infusion is prepared.

The invention will be explained below in closer detail by reference to embodiments and the drawings, wherein:

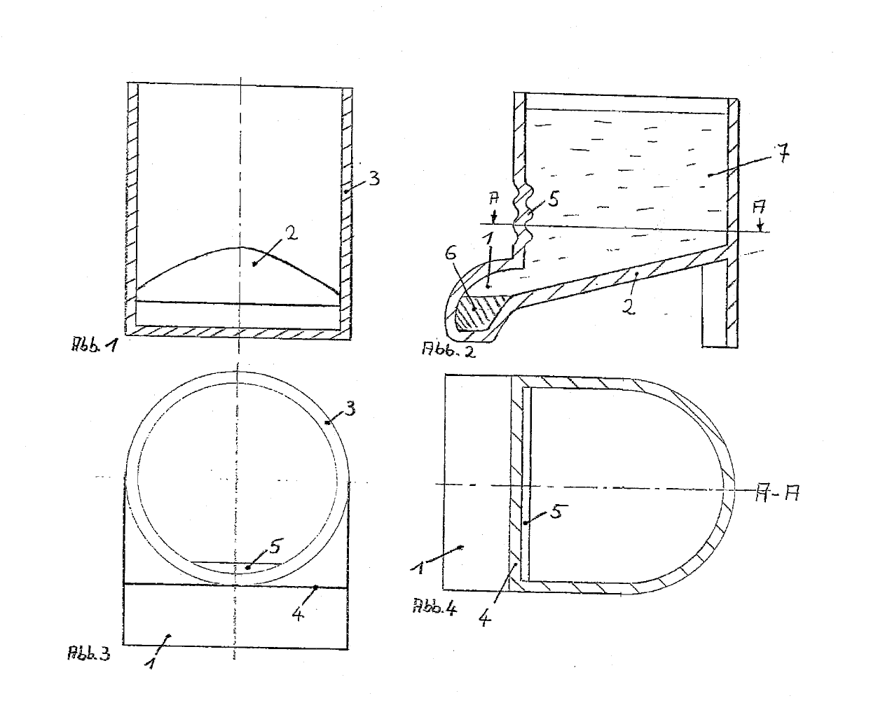

FIGS. 1 to 4 show different views of a first embodiment of a vessel, which is formed as a drinking cup, with FIG. 1 showing a front sectional view of the vessel.

FIG. 2 shows a sectional side view of the exemplary vessel according to the first embodiment;

FIG. 3 shows a top view of the vessel according to the first embodiment, and

FIG. 4 shows a sectional view along the line A-A according to FIG. 2.

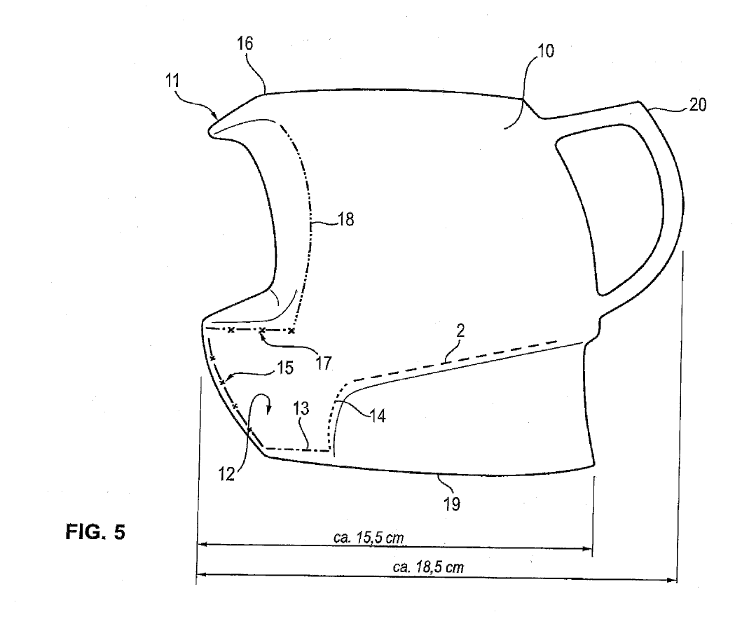

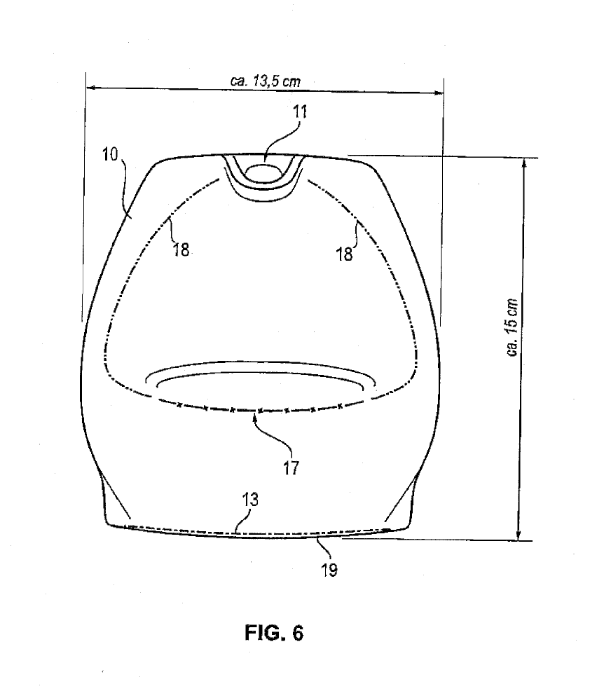

A further embodiment of the vessel in accordance with the invention is shown in FIGS. 5 and 6 in form of a brewing pot.

FIG. 5 shows a side view of the pot according to a second embodiment, and FIG. 6 shows a front view of the brewing pot, namely in the direction of the spout-shaped outlet which can be recognised in the upper region of the figurative representation.

According to the illustrations in accordance with FIGS. 1 to 4, the first embodiment comprises a brewing drinking cup in form of a coffee cup for example. The coffee cup comprises a retaining volume 1 in which the coffee grounds 6 of a brewed coffee 7 can settle. In this respect, the bottom of the vessel is realised as an inclined plane 2. Ribbing 5 in form of projections and recesses is further present in the front region of the vessel, above the retaining volume 1. A flattening section 4 ensures that the coffee 7 will flow off via a broad, evenly thin flow. When inspecting the vessel, potentially entrained residual coffee grounds can be recognised as an insoluble infusion component. The brewing process occurs after coffee powder was introduced into the vessel according to the first embodiment. Subsequently, the coffee grounds settle on the inclined plane 2 and reach the retaining volume or the retaining space 1 as a result of gravity and accumulate there (reference numeral 6).

The forwardly directed bulbous portion with the bulge relating to the bottom end of the inclined plane 2 produces a retaining of the coffee grounds 3 and also ensures that the infusion liquid level is prevented from dropping beneath the level of the insoluble infusion constituents 6.

The retaining volume can principally be formed in different ways as long as the conditions explained in claim 1 are fulfilled, i.e. that secure receiving of insoluble infusion constituents occurs and they are securely retained during the pouring-out process.

The second embodiment is based on a brewing pot 10. The brewing pot 10 comprises a spout-shaped outlet 11 and consists of a vessel body which surrounds an inner cavity.

A reservoir space 12 is disposed in said inner space which represents the retaining volume 1.

The inclined plane 2, which also extends in the inner volume, is indicated with the dashed line.

The reservoir space 12 comprises a bottom section 13 beneath the inclined plane 2, in which FIG. 5 is shown with the dot-dash line.

A connecting section 14, which is represented by a dashed line, extends between the bottom section 13 and the inclined plane 12.

A bulbous retaining section 15 is further present, which is opposite the connecting section 14, is effective during the pouring-out drinking process and is symbolised in FIG. 5 by a dash-cross line.

The aforementioned spout-shaped outlet 11 is formed above the reservoir space 12, namely in the region of the upper edge 16.

A recess 17 is disposed between the retaining section 15 and the spout 11, symbolised by a dot-dash-cross line.

The recess 17 converges into a funnel segment 18, which is obtained from the overall view of the illustrations according to FIGS. 5 and 6. The funnel segment 18 is represented by a dash-dot-dot-dash line.

The funnel segment 18 produces in conjunction with the recess 17 and the retaining section 15 a suppression of a flow-induced swirling of infusion constituents situated in the reservoir space 12.

The pot-shaped brewing vessel 10 comprises a flat outer bottom 19 and a known handle 20. The dimensions stated in FIGS. 5 and 6 are merely exemplary and do not represent any limitation concerning a potential scaling of respective dimensional sizes.

Although no ribbing in form of projections and recesses 5 as in the first embodiment are shown in the embodiment according to FIGS. 5 and 6, it is obviously possible to form the respective ribbing in the respective section 18, i.e. in the region of the funnel segment 18.

1. A vessel (10) for the preparation of infusion beverages with a retaining volume (1) for insoluble infusion constituents, consisting of a vessel body with a bottom which is formed as an inclined plane (2) and converges at the base point into the retaining volume (1), characterized in that the retaining volume is formed as a reservoir space (12) which comprises a flat bottom section (13) extending beneath the inclined plane (2), a connecting section (14) directed towards the inclined plane (2), and, opposite the connecting section (14), a bulbous retaining section (15) which is effective during the pouring-out or drinking process in such a way that the infusion liquid level is prevented from dropping below the level of the insoluble infusion constituents.

2. A vessel according to claim 1, characterized in that it comprises a spout-shaped outlet (11) which is formed above the reservoir space (12) at the upper edge (16) of the vessel body, wherein a recess (17) is disposed between the retaining section (15) and the outlet (11), said recess converging into a funnel segment (18) in order to suppress flow-induced swirling of infusion constituents situated in the reservoir space (12).

3. A vessel according to claim 1, characterized in that the vessel body comprises cascade-shaped projections and recesses (5) above the reservoir space (12).

4. A vessel according to claim 1, characterized in that the vessel body has a cylindrical, partly cylindrical or oval shape.

5. A vessel according to claim 1, characterized in that the inclined plane (2) is formed as a brewing surface.

6. A vessel according to claim 1, characterized in that it is formed as a drinking cup or brewing pot.
